(19) United States
(12) Patent Application Publication
(10) Pub. No.: US 2014/0190210 A1
(43) Pub. Date: Jul. 10, 2014

(54) Method for Bonding Substrates

(71) Applicant: LILLIPUTIAN SYSTEMS, INC., Wilmington, MA (US)

(72) Inventors: Mohammad Masyood Akhtar, North Reading, MA (US); Zachary Byars, Cambridge, MA (US); Samuel B. Schaevitz, Concord, MA (US)

(73) Assignee: LILLIPUTIAN SYSTEMS, INC., Wilmington, MA (US)

(21) Appl. No.: 13/734,884

(22) Filed: Jan. 4, 2013

(51) Int. Cl. C03C 8/24

(52) U.S. Cl. CPC C03C 8/24
USPC 65/23

(57) ABSTRACT

The method for bonding a first substrate to a second substrate includes dispensing a paste directly onto a first substrate, the paste including a glass powder, a thermoplastic, and a first solvent, evaporating the first solvent to form a thickened paste, placing a second substrate on the thickened paste to form a stack, applying to the stack a force sufficient to cause deformation of the thickened paste, and heating the stack to a bonding temperature above a glass transition temperature of the glass powder so as to cause removal of the thermoplastic from the thickened paste and to form a glass joint between the first and second substrates.

### CROSS REFERENCE TO RELATED APPLICATIONS

The present application is related to U.S. Patent Application entitled FUEL CELL SYSTEMS AND RELATED METHODS, Attorney Docket No. 3553/138, filed on Jan. 4, 2013, U.S. Patent Application entitled A FUEL CELL SYSTEM HAVING AN AIR QUALITY SENSOR SUITE, Attorney Docket No. 3553/139, filed on Jan. 4, 2013, U.S. Patent Application entitled FUEL CELL SYSTEM HAVING A PUMP AND RELATED METHOD, Attorney Docket No. 3553/141, filed on Jan. 4, 2013, U.S. Patent Application entitled A FUEL CELL SYSTEM HAVING WATER VAPOR CONDENSATION PROTECTION, Attorney Docket No. 3553/142, filed on Jan. 4, 2013, U.S. Patent Application entitled A FUEL CELL SYSTEM HAVING A SAFETY MODE, Attorney Docket No. 3553/143, filed on Jan. 4, 2013, U.S. Patent Application entitled A PORTABLE FUEL CELL SYSTEM HAVING A FUEL CELL SYSTEM CONTROLLER, Attorney Docket No. 3553/144, filed on Jan. 4, 2013, and U.S. Patent Application entitled LOW VIBRATION LINEAR MOTOR SYSTEMS, Attorney Docket No. 3553/146, filed on Jan. 4, 2013, the disclosures of which are incorporated by reference herein in their entirety.

### TECHNICAL FIELD

The present invention relates to a method for bonding substrates, and more particularly to a method of forming a stack of substrates for use in a fuel cell.

### BACKGROUND ART

Fuel cells produce electricity from chemical reactions. The chemical reactions typically cause a fuel, such as hydrogen, to react with air/oxygen as reactants to produce water vapor as a primary by-product. The hydrogen can be provided directly, in the form of hydrogen gas or liquid, or can be produced from other materials, such as hydrocarbon liquids or gasses. Fuel cell assemblies may include one or more fuel cells in a fuel cell housing that is coupled with a fuel canister containing the hydrogen and/or hydrocarbons. Fuel cell housings that are portable coupled with fuel canisters that are portable, replaceable, and/or refillable, compete with batteries as a preferred electricity source to power a wide array of portable consumer electronics products, such as cell phones and personal digital assistants. The competitiveness of these fuel cell assemblies when compared to batteries depends on a number of factors, including their size, efficiency, and reliability.

In a high temperature fuel cell system, such as a solid oxide fuel cell (SOFC) system, an oxidizing flow is passed through the cathode side of the fuel cell while a reducing flow is passed through the anode side of the fuel cell. The oxidizing flow is typically air, while the reducing flow typically comprises a mixture of a hydrogen-rich gas created by reforming a hydrocarbon fuel source with an oxygen source, such as air, water vapor or carbon dioxide. The fuel cell also has an electrolyte, which carries electrically charged particles from one electrode to the other, and a catalyst, which speeds the reaction at the electrodes. The electrolyte plays a key role. It must permit only the appropriate ions to pass between the anode and cathode. Typically the SOFC systems use a solid oxide or ceramic electrolytes. The fuel cell, typically operating at a temperature between 500° C. and 1000° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between the anode and the cathode, resulting in an electrical current flow through the circuit.

The planar fuel cell design geometry is one of the typical geometries employed in fuel cells. Another typical geometry is a tubular design. A planar sandwich design can be implemented by most types of fuel cells including the SOFC systems, wherein the electrolyte is sandwiched between the anode and cathode electrodes, thereby forming a so-called membrane-electrode stack. The ceramic membranes used in SOFCs do not become electrically and ionically active until they reach very high temperatures and as a consequence the stacks have to run at temperatures ranging from 500 degrees C. to 1000 degrees C. as was mentioned supra. These high operating temperatures present some challenges hindering the SOFC technology. The components and interconnects in high temperature fuel cells must exhibit thermo-mechanical compatibility: their thermal expansion coefficients must match, and the materials must be tough enough and have similar enough thermo-mechanical properties to withstand mechanical stresses due to difference in thermal expansion. Furthermore, the material forming the bond between the layers in the stack must also be able to withstand the stress, temperatures and chemicals present in the fuel cell. Additionally, the process for creating such a stack must be reliable and compatible with high volume production techniques. The prior art fuel cell systems incorporate stacks that are prone to developing cracks upon thermal cycling and exhibiting thermal stress-induced failures at interconnects joining the components. Therefore, there is a need to provide a method for bonding fuel cell components, which results in fuel cell stacks that can withstand mechanical stresses upon thermal cycling and therefore can be effectively used in portable fuel cell systems that require a high-quality, long-lasting, and reliable power supply.

Glass frit materials are commonly used to bond together two substrates. One process used in the prior art consists of dispensing a paste containing a glass powder, a solvent, and a binder. The solvent is then evaporated to form a dried paste. The paste and substrate are then heated above the glass transition temperature of the glass to both remove the binder and to sinter the glass powder into a “glazed” frit. A second substrate is then applied, and force is applied while re-heating above the glass transition temperature of the glass to reflow the glass and bond the two substrates together. Similar prior art techniques use a pre-glazed glass preform inserted between the two substrates prior to the final heating step. Various combinations of glazing and then final firing are known in the art.

Unfortunately, many glasses have very high viscosities at the desired bonding temperature, which requires excessive force to deform the glazed frit, and may damage portions of the substrate. In addition, the dispensed or placed glazed frit may have substantial non-uniformity, requiring excessive flow of the glass during bonding. These challenges often result in low strength, leaking, porous and low-yielding bonding.

### SUMMARY OF THE EMBODIMENTS

In one embodiment of the invention, a method for bonding a first substrate to a second substrate includes dispensing a paste directly onto the first substrate, the paste including a glass powder, a thermoplastic, and a first solvent, evaporating the first solvent to form a thickened paste, and placing the second substrate on the thickened paste to form a stack. The method further includes applying to the stack a force sufficient to cause deformation of the thickened paste, and heating the stack to a bonding temperature above a glass transition temperature of the glass powder so as to cause removal of the thermoplastic from the thickened paste and to form a glass joint between the first and second substrates.

In related embodiments, the applying and heating processes may be performed simultaneously or may be performed sequentially. For example, the applying process may be performed before the heating process or the applying process may be performed after the heating process has begun and before the removal of the thermoplastic has completed. The paste may further include a second solvent that evaporates more slowly than the first solvent during the evaporating process, and evaporating the first solvent may include evaporating substantially all of the first solvent while retaining a substantial portion of the second solvent in the thickened paste.

In related embodiments, the method may further include bonding more than two substrates together by dispensing the paste directly onto a plurality of substrates, and placing all of the substrates into the stack. Evaporating the first solvent may include heating the first substrate to a temperature between about 40 and about 200 degrees Celsius. The method may further include, before applying the force, heating the stack above a glass transition temperature of the thermoplastic. Applying the force may include maintaining the force on the stack during the process of heating the stack above the glass transition temperature of the thermoplastic. Heating the stack may include first heating the stack to a burnout temperature to cause removal of the thermoplastic and then heating the stack to the bonding temperature. Dispensing the paste may include forming the paste into a shape on the first substrate, the shape including a strip having a longitudinal axis along a surface of the first substrate, a thickness in a direction normal to the surface, and a width along the surface and normal to the longitudinal axis, wherein the ratio of the width to the thickness is less than about 40. Applying the force may include applying sufficient force that the maximum thickness of the shape is reduced by at least 10% after the force has been applied to the stack. Dispensing the paste may include forming the paste into a shape on the first substrate, the shape covering an area on a surface of the first substrate, and wherein the force in Newtons per unit of the area in square millimeters is greater than 0.1 Newtons per square millimeter. The dispensing process may include applying the paste by screen-printing or applying the paste via a nozzle.

### BRIEF DESCRIPTION OF THE DRAWINGS

The foregoing features of embodiments will be more readily understood by reference to the following detailed description, taken with reference to the accompanying drawings, in which:

FIG. 1A is a flow chart illustrating a process for bonding two substrates according to an illustrative embodiment of the present invention.

FIGS. 1B-1D are schematic illustrations of the bonding process shown in FIG. 1A according to an illustrative embodiment of the present invention.

FIG. 2A is a flow chart illustrating a process for bonding more than two substrates according to an illustrative embodiment of the present invention.

FIGS. 2B-2D are schematic illustrations of the bonding process shown in FIG. 2A according to an illustrative embodiment of the present invention.

FIG. 3 is a flow chart diagram illustrating another process for bonding substrates according to an illustrative embodiment of the present invention.

FIG. 4 is a schematic illustration of dispensing a paste onto a substrate by forming the paste into a shape according to an illustrative embodiment of the present invention.

FIGS. 5A-5C are schematic illustrations of deforming a paste upon application of a force according to an illustrative embodiment of the present invention.

FIGS. 6A and 6B are schematic illustrations of dispensing a paste onto a substrate by forming the paste into various shapes according to illustrative embodiments of the present invention.

### DETAILED DESCRIPTION OF SPECIFIC EMBODIMENTS

Definitions. As used in this description and the accompanying claims, the following terms shall have the meanings indicated, unless the context otherwise requires:

A “substrate” is a solid body comprising glass, ceramic, metal, semiconductor material, or a combination thereof.

A “glass frit” is a powdered glass material.

A “glazed frit” is glass frit that has been heated to a sufficient temperature for a sufficient time to allow the particles of the frit to bond to each other and/or to a substrate in contact with the frit.

We have found that the prior art process for forming a glass bond can be improved dramatically by the addition of a thermoplastic deformation step prior to the removal of the binder. This step allows the dispensed glass paste with an irregular thickness to be molded to the exact shape required for the subsequent bonding operation and therefore reduces significantly the required glass flow to form a high quality bond. In order to add the thermoplastic deformation step, two changes to the standard process are required. First, the binder must be selected to be a thermoplastic. Preferably, the ratio of thermoplastic to glass frit is selected to allow the required deformation at the desired pressure and temperature available in a given application. Second, the addition of a force on the assembly prior to glazing of the glass frit is needed. Preferably, the force is sufficient to substantially deform at least a portion of the dispensed glass paste. These additional changes can be executed using methods and materials known in the art, and we have found that they have a very profound positive effect on the resulting bond.

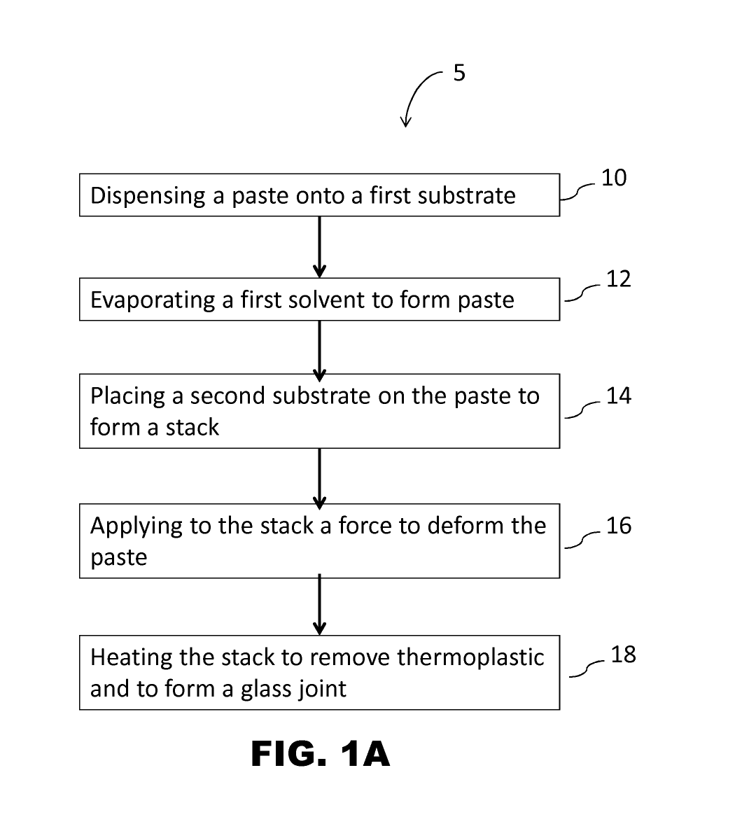

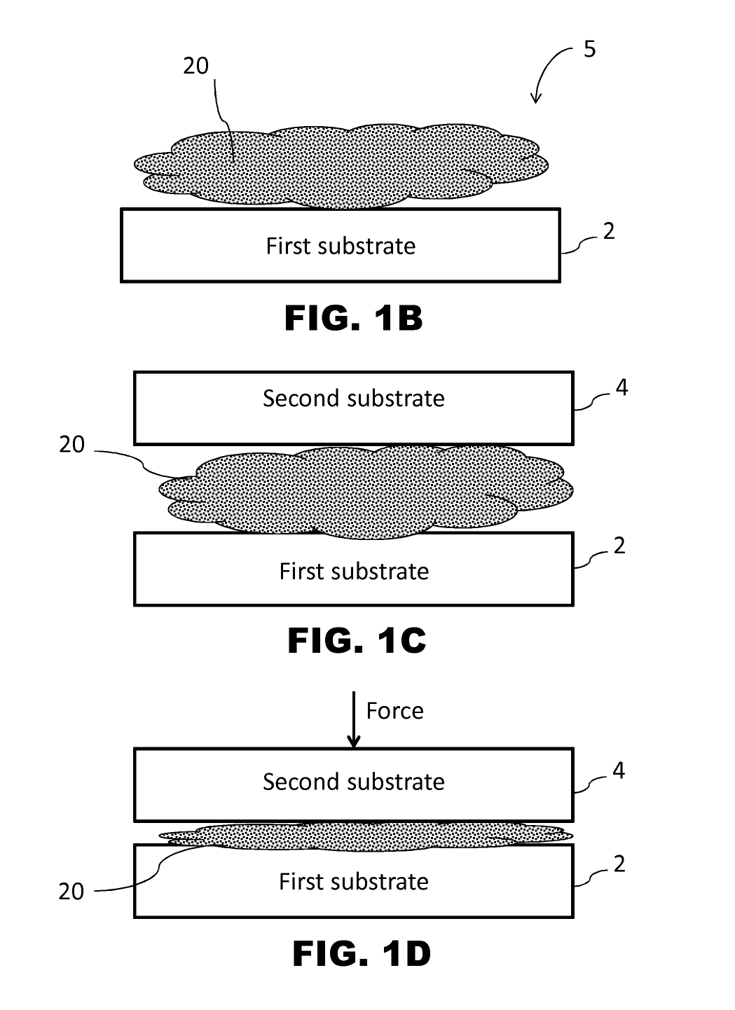

FIG. 1A illustrates a process for bonding a first substrate 2 to a second substrate 4 according to one embodiment of the present invention. The method 5 begins by dispensing a paste 20, which includes a glass powder, a thermoplastic and a first solvent, directly onto the first substrate 2 (step 10), as shown in FIG. 1B, evaporating the first solvent to form a thickened paste 20 (step 12), and placing the second substrate 4 on the thickened paste 20 to form a stack (step 14), as shown in FIG. 1C. The method 5 further includes applying to the stack a force sufficient to cause deformation of the thickened paste 20 (step 16), as shown in FIG. 1D, and heating the stack to a bonding temperature above a glass transition temperature of the glass powder so as to cause removal of the thermoplastic from the thickened paste 20 and to form a glass joint between the first 2 and second substrates 4 (step 18). In some embodiments, the applying process (step 16) and the heating process (step 18) can be performed simultaneously. In some other embodiments, the applying process (step 16) is performed before the heating process (step 18), e.g., the processes are performed sequentially. According to one embodiment of the present invention, the applying process (step 16) is performed after the heating process (step 18).

In some embodiments, the paste 20 can include a second solvent that evaporates more slowly than the first solvent during the evaporating process (step 12). Evaporating the first solvent may include evaporating substantially all of the first solvent, while retaining a substantial portion of the second solvent in the thickened paste 20.

In some embodiments, the step of evaporating the first solvent (step 12) can be done by heating the first substrate 2 to a temperature between about 40 and about 200 degrees Celsius. More preferably, the evaporation step is done between about 40 and 100 degrees Celsius. Lower drying temperatures have been found to be unreliable due to environmental variability, and often take undue time. Higher drying temperatures can cause the dried paste to be excessively stiff, requiring excess force in the subsequent thermoplastic deformation step (step 16).

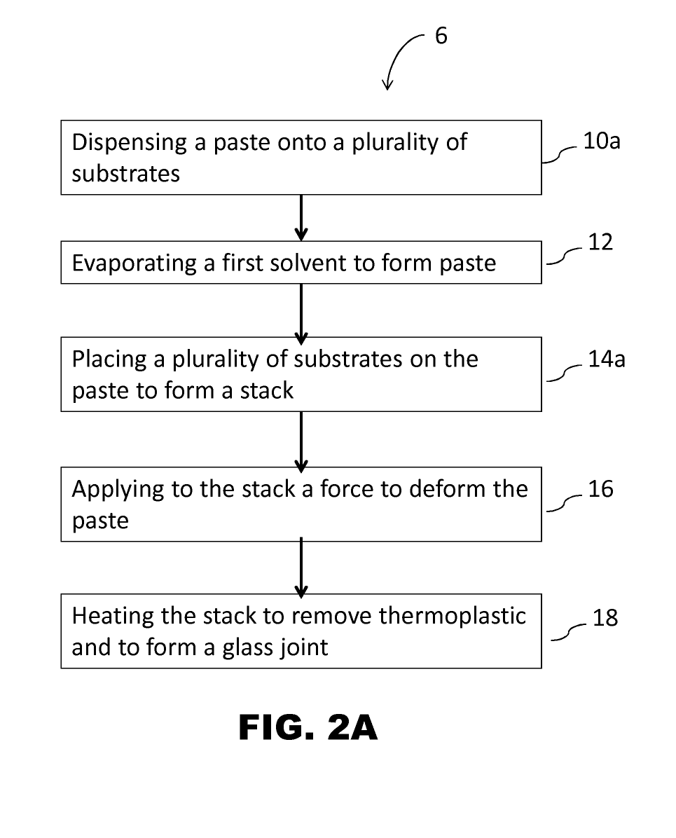

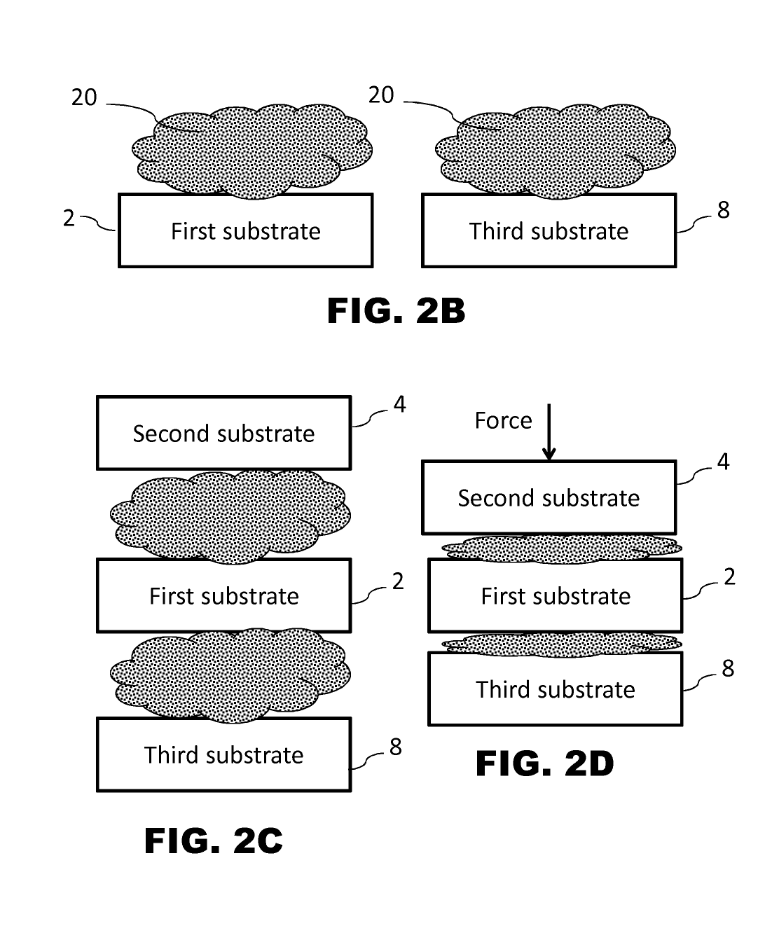

FIG. 2 illustrates a process of bonding more than two substrates together according to one embodiment of the present invention. The method 6 includes dispensing a paste, which includes a glass powder, a thermoplastic and a first solvent, directly onto a plurality of substrates (e.g., first substrate 2 and third substrate 8) (step 10a), as shown in FIG. 2B, evaporating the first solvent to form a thickened paste 20 (step 12), and placing the plurality of substrates on the thickened paste 20 to form a stack (step 14a), as shown in FIG. 2C. The method 6 further includes applying to the stack a force sufficient to cause deformation of the thickened paste 20 (step 16), as shown in FIG. 2D, and heating the stack to a bonding temperature above a glass transition temperature of the glass powder so as to cause removal of the thermoplastic from the thickened paste and to form a glass joint between the plurality of substrates (2, 4, 8) (step 18). In some embodiments, the method can include heating the stack above a glass transition temperature of the thermoplastic before applying the force (step 16). According to one embodiment of the present invention, applying the force (step 16) can be performed by maintaining the force on the stack during the process of heating the stack above the glass transition temperature of the thermoplastic.

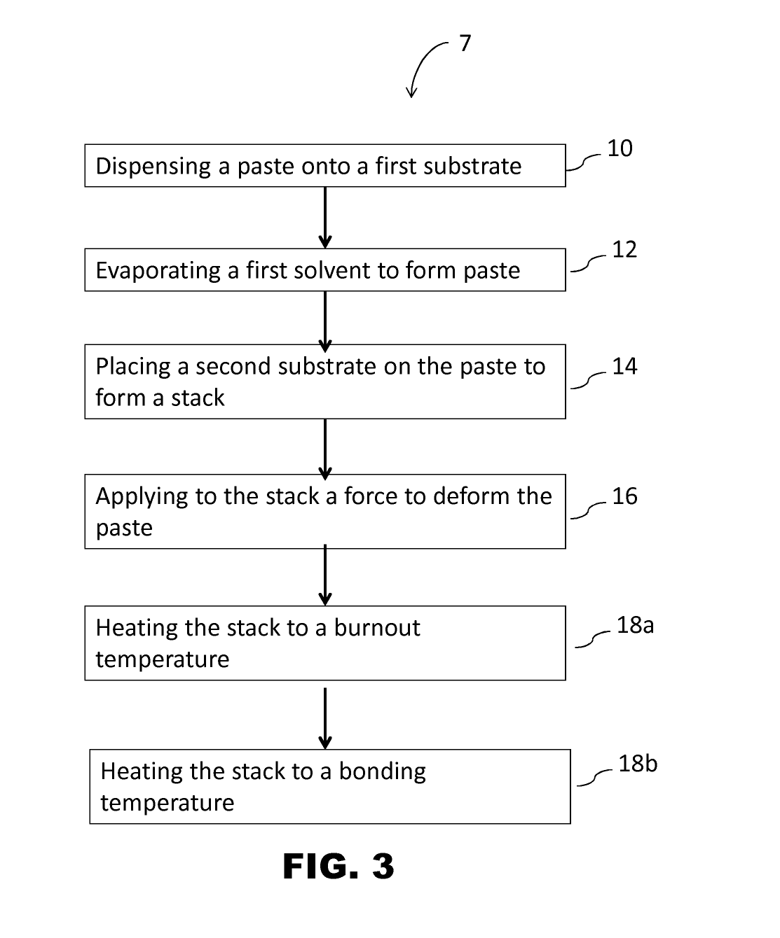

According to one embodiment, as illustrated in FIG. 3, a process 7 of heating the stack includes first heating the stack to a burnout temperature to cause removal of the thermoplastic (step 18a) and then heating the stack to the bonding temperature (step 18b).

The thermoplastic selected preferably has a burnout temperature substantially lower than the glass transition temperature of the glass frit. This allows the thermoplastic burnout products to escape between the particles of the glass frit before the glass begins to densify and seal. Preferably, the burnout temperature is at least 50 degrees Centigrade lower than the glass transition temperature of the glass frit. More preferably, the burn out temperature is at least 100 degrees Centigrade lower than the glass transition temperature of the glass frit. Most preferably, the burn out temperature is at least 150 degrees Centigrade lower than the glass transition temperature of the glass frit. Larger differences in temperature provide greater process flexibility in selecting temperatures and times for the burnout.

To further support the burnout of the thermoplastic, it is advantageous for the glass frit selected to have a glass transition temperature of at least 300 degrees Centigrade. More preferably, the glass frit is selected to have a glass transition temperature of at least 400 degrees Centigrade. Most preferably, the glass frit is selected to have a glass transition temperature of at least 550 degrees Centigrade.

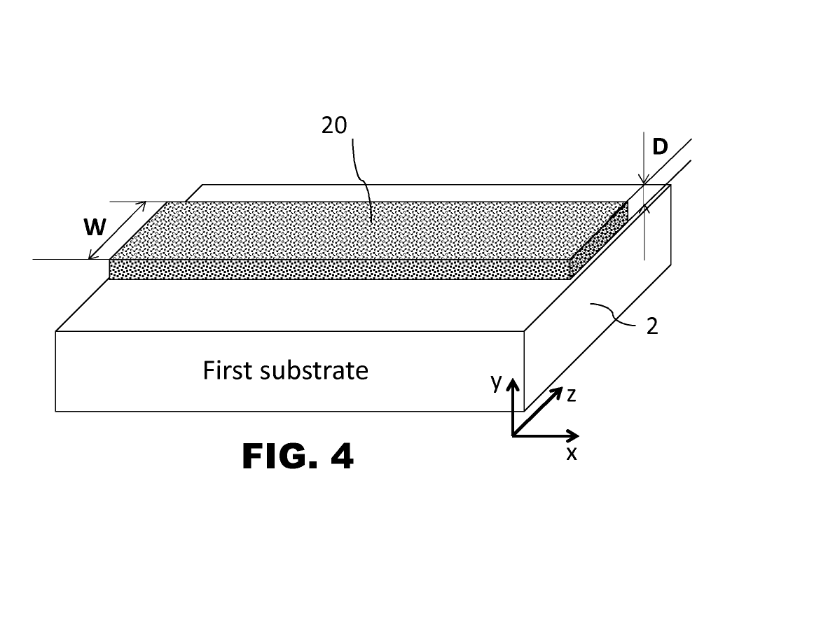

As illustrated in FIG. 4, dispensing a paste can include forming the paste 20 into a shape on the first substrate 2, the shape includes a strip having a longitudinal axis x along a surface of the first substrate, a thickness D in a direction normal to the surface (an axis y) and a width W along the surface and normal to the longitudinal axis x (an axis z). To allow for sufficient motion in the thermoplastic deformation step, it is advantageous for the shape to have a reasonable width to thickness ratio such that thermoplastic deformation can move material from the middle of the substrate toward the edges of the substrate with a reasonable force. We have found that it is preferable that the ratio of the width W to the thickness D is less than about 40 in the thickened paste. It is more preferable for the ratio of the width W to the thickness D to be between 1 and 20 in the thickened paste. It is most preferable for the ratio of the width W to the thickness D to be between 2 and 10 in the thickened paste.

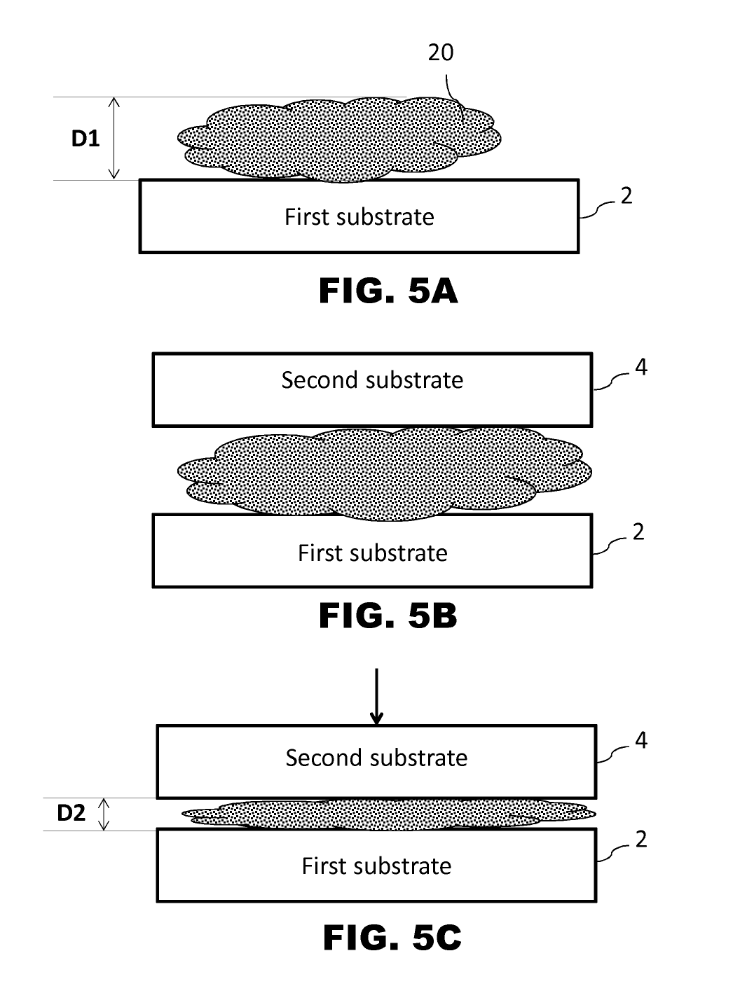

In some embodiments, as shown in FIGS. 5A-5C, the initial maximum thickness D1 of the paste 20 is reduced to the thickness D2 by at least 10% after the force has been applied to the stack.

In certain embodiments, the thermoplastic deformation step results in the thickened paste 20 molded to a form which is in intimate contact with the second substrate 4 over a substantial portion of the dispensed area. Preferably, the intimate contact area is >10% of the dispensed area. More preferably, the intimate contact area is >30% of the dispensed area. This intimate contact area will need minimal additional glass flow to form a high quality bond.

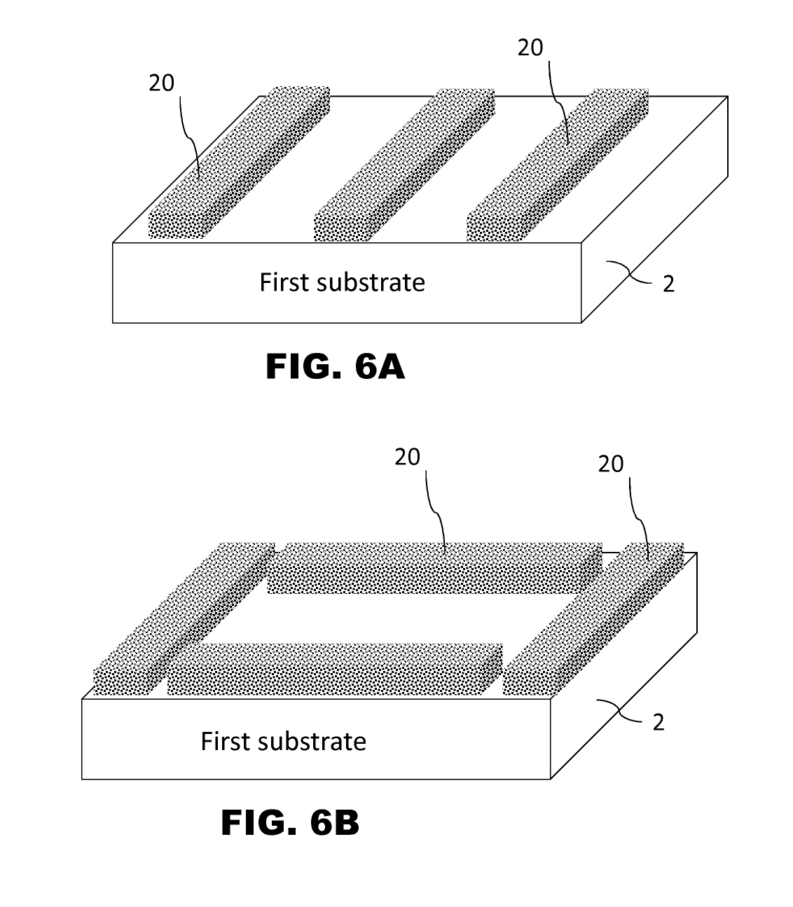

According to one embodiment of the present invention, the process of dispensing the paste can include forming the paste 20 into a shape on the first substrate 2 so it covers an area on a surface of the first substrate 2, as shown in FIGS. 6A and 6B, such that the force in Newtons per unit of the area is greater than 0.1 Newton per square millimeter. Preferably, the force is greater than 0.3 Newton per square millimeter. Most preferably, the force is greater than 0.5 Newton per square millimeter. The paste 20 can be dispensed in a variety of different ways, such as, for example, around the perimeter of the substrate 2, as shown in FIG. 6B, or along the length of the substrate 2, as shown in FIG. 6A, or in the middle of the substrate 2, as shown in FIG. 4, using one strip or plurality of strips. The paste 20 can be formed into a variety of shapes and forms, such as approximately rectangular strips as shown in FIGS. 4, 6A, and 6B, for example, or shapes such as shown in FIG. 1B, for example. The paste 20 can have a square or oval shape, or other suitable shapes. The process of dispensing the paste 20 can be performed by using a screen-printing technique. In some embodiments, the paste 20 can be dispensed using a nozzle dispensing method.

The thermoplastic can be selected from various synthetic polymers such as polymethylmethacrylate (PMMA), polycarbonate (PC), polystyrene (PS), cyclic olefin polymers (COP), cyclic olefin copolymers (COC), polypropylene (PP), polyetheretherketone (PEEK), polyethylene terephthalate (PET), polyethylene (PE), polyvinyl chloride (PVC), polyvinylidene chloride (PVDC), polysulfone (PSU), polyvinyl acetate (PVAc) and polyvinyl alcohol (PVOH), or any other suitable thermoplastics which exhibit softening behavior above a characteristic glass transition temperature (Tg) resulting from long-range motion of the polymer backbone, while returning to their original chemical state upon cooling. Polyvinyl acetate is a preferred thermoplastic.

The first and second solvents can be selected from cyclohexane, acetone, isopropanol, ethanol, methanol, terpineol, Texanol™ (produced by Eastman Chemical Company), Isopar™ (produced by Exxonmobil Chemical Company), Exxal™ (series 3-15 produced by Exxonmobil Chemical Company), Nikane™ (MS-series solvent produced by The Dow Chemical Company), Avantane™ (produced by The Dow Chemical Company), propylene carbonate, methyl ethyl ketone (MEK), Takenate™ (produced by Mitsui Chemicals) Flexitane™ 6000 (produced by The Down Chemical Company), dimethyl adopate, or any other suitable solvent. Preferably, the second solvent is selected to have an evaporation rate less than 0.5 times the evaporation rate of the first solvent during the evaporation step. More preferable, the second solvent is selected to have an evaporation rate less than 0.2 times the evaporation rate of the first solvent during the evaporation step. Terpineol is a preferred solvent.

The average particle size of glass powder is preferably in the range from about 1 microns to about 100 microns, and more preferably from about 5 microns to about 60 microns.

The amounts of glass powder, thermoplastic and solvent in the paste 20 can vary, partially depending on the molecular weight and type of the thermoplastic. Sufficient thermoplastic should be provided to allow the glass frit particles to move easily relative to each other during the thermoplastic deformation step. Excessive thermoplastic causes two problems, excessive motion during thermoplastic deformation and excessive shrinkage during burnout. According to some exemplary formulations, the solid volume ratio of the glass powder to the thermoplastic can be in the range from 20:1 to 0.1:1, more preferably the ratio is in the range of 5:1 to 0.5:1, and most preferably the ratio is in the range of 2:1 to 0.5:1.

The methods of the present invention described above solve the challenges associated with high operating temperatures of the SOFC systems by providing fuel cell stacks that are much less prone to developing cracks upon thermal cycling and are much less likely to exhibit thermal stress-induced failures at interconnects joining the fuel cell components. Therefore, there are provided methods of the present invention, which result in fuel cell stacks that can withstand mechanical stresses upon thermal cycling and thus can be effectively used in portable fuel cell systems that require a high-quality, long-lasting, and reliable power supply.

The embodiments of the invention described above are intended to be merely exemplary; numerous variations and modifications will be apparent to those skilled in the art. All such variations and modifications are intended to be within the scope of the present invention as defined in any appended claims. For example, although some features may be included in some embodiments and drawings and not in others, these features may be combined with any of the other features in accordance with embodiments of the invention as would be readily apparent to those skilled in the art based on the teachings herein.

What is claimed is:

1. A method for bonding a first substrate to a second substrate, the method comprising:
dispensing a paste directly onto the first substrate, the paste including a glass powder, a thermoplastic, and a first solvent;
evaporating the first solvent to form a thickened paste;
placing the second substrate on the thickened paste to form a stack;
applying to the stack a force sufficient to cause deformation of the thickened paste; and
heating the stack to a bonding temperature above a glass transition temperature of the glass powder so as to cause removal of the thermoplastic from the thickened paste and to form a glass joint between the first and second substrates.

2. A method according to claim 1, wherein the applying and heating processes are performed simultaneously.

3. A method according to claim 1, wherein the applying and heating processes are performed sequentially.

4. A method according to claim 3, wherein the applying process is performed before the heating process.

5. A method according to claim 3, wherein the applying process is performed after the heating process has begun and before the removal of the thermoplastic has completed.

6. A method according to claim 1, wherein the paste further includes a second solvent that evaporates more slowly than the first solvent during the evaporating process, and evaporating the first solvent includes evaporating substantially all of the first solvent while retaining a substantial portion of the second solvent in the thickened paste.

7. A method according to claim 1, for bonding more than two substrates together, further comprising:
dispensing the paste directly onto a plurality of substrates; and
placing all of the substrates into the stack.

8. A method according to claim 1, wherein evaporating the first solvent comprises heating the first substrate to a temperature between about 40 and about 200 degrees Celsius.

9. A method according to claim 1, further comprising:
before applying the force, heating the stack above a glass transition temperature of the thermoplastic.

10. A method according to claim 1, wherein applying the force includes maintaining the force on the stack during the process of heating the stack above the glass transition temperature of the thermoplastic.

11. A method according to claim 1, wherein heating the stack includes first heating the stack to a burnout temperature to cause removal of the thermoplastic and then heating the stack to the bonding temperature.

12. A method according to claim 1, wherein dispensing the paste includes forming the paste into a shape on the first substrate, the shape comprising a strip having a longitudinal axis along a surface of the first substrate, a thickness in a direction normal to the surface, and a width along the surface and normal to the longitudinal axis, wherein the ratio of the width to the thickness is less than about 40.

13. A method according to claim 12, wherein applying the force includes applying sufficient force that the maximum thickness of the shape is reduced by at least 10% after the force has been applied to the stack.

14. A method according to claim 1, wherein dispensing the paste includes forming the paste into a shape on the first substrate, the shape covering an area on a surface of the first substrate, and wherein the force in Newtons per unit of the area in square millimeters is greater than 0.1 Newtons per square millimeter.

15. A method according to claim 1, wherein dispensing includes applying the paste by screen-printing.

16. A method according to claim 1, wherein dispensing includes applying the paste via a nozzle.
